(19) United States
(12) Patent Application Publication
(10) Pub. No.: US 2014/0244889 A1
(43) Pub. Date: Aug. 28, 2014

(54) PCI-E REFERENCE CLOCK PASSIVE SPLITTER AND METHOD THEREOF

(71) Applicant: WILOCITY LTD., Caesarea (IL)

(72) Inventor: Ori SASSON, Nesher (IL)

(73) Assignee: WILOCITY LTD., Caesarea (IL)

(21) Appl. No.: 14/192,288

(22) Filed: Feb. 27, 2014

Related U.S. Application Data
(60) Provisional application No. 61/769,922, filed on Feb. 27, 2013.

(51) Int. Cl. G06F 13/40

(52) U.S. Cl. CPC G06F 13/4022
USPC 710/316

(57) ABSTRACT

A passive electronic circuit for splitting a Peripheral Component Interconnect Express (PCIe) reference clock is provided. The circuits comprises two splitting paths coupled between a clock driver and a plurality of loads, wherein each of the two splitting paths is connected, at one end through a first transmission line, to one output of a differential PCIe reference clock provided by the clock driver; wherein each of the two splitting paths includes a plurality of splitter branches, wherein each splitting branch comprises a first resistor connected in series to a second transmission line being connected in a series to a second resistor, wherein the second resistor is coupled to an input of one of the plurality of loads and the first resistor is coupled to the first transmission line through a splitting point.

### CROSS-REFERENCE TO RELATED APPLICATIONS

This application claims the benefit of U.S. provisional application No. 61/769,922 filed on Feb. 27, 2013, the contents of which is herein incorporated by reference.

### TECHNICAL FIELD

The present invention generally relates to Peripheral Component Interconnect Express buses, and particularly to a reference clock of such buses.

### BACKGROUND

Peripheral Component Interconnect Express (PCI Express or PCIe) is a high performance, generic and scalable system interconnect for a wide variety of applications ranging from personal computers to embedded applications. The PCIe implements serial, full duplex, multi-lane, point-to-point interconnect, packet-based, and switch based technology. Current versions of PCIe buses allow for a transfer rate of 2.5 Giga bit per second (Gbps) or 5 Gbps, per lane, with up to 32 lanes.

The PCIe standard, for example, PCI Express base Specification reversion 1.0a issued on Apr. 15, 2003, requires a reference clock for the operation of the bus. The PCIe Card Electromechanical Specification, revision 2.0 issued on Apr. 11, 2007, hereinafter referred to as the PCIe specification, defines a differential square-wave reference clock of 100 MHz fundamental frequency as a reference clock. The reference clock load is a high impedance load. The PCIe specification also defines a reference load of a 2 pF capacitor. Typically, the routing of a reference clock signal is allowed to be electrically long. The route for the clock signal is generally composed of one or more PCIe connectors and line segments having a length of above 10 inches. Delivering signals over such lengths without electrical matching may result in significant reflections, which may cause clock distortions and lead to excessive jitter. In such events, the bus performance may be deteriorated or the bus can be completed disabled.

In order to reduce reflections, the PCIe specification defines requirements for a clock driver, clock routing, and loads. Such requirements are designed to support one load connected to a clock signal, through a clock driver. However, connecting two or more loads in parallel to one clock driver may significantly downgrade the performance of the PCIe bus because the loads are not necessarily physically close and the connection point introduces discontinuity, which is prone to significant reflections.

One solution to avoid reflections and ensure that an undistorted or “clean” PCIe reference clock is delivered to multiple loads is achieved by an active splitter. Generally, an active splitter presents a single load to the clock driver and includes internal clock drivers that replicate and amplify the reference clock signal to compensate for signal lost due to the splitting. For example, the signal is replicated 4 times and delivered to four different clients. An active splitter requires a power source to operate. As such an active splitter consumes high power due to operations of its internal drivers. Furthermore, an active splitter also occupies a relatively large area of the board and is relatively costly with regard to passive components (e.g., resistors). This is a significant limitation for designing a handheld computing device (e.g., smartphones, laptops, tablet computers, etc.) where battery life and size of the design are typically uncompromising design constraints.

Therefore, it would be advantageous to provide an efficient solution for splitting a PCIe reference clock that would overcome the deficiencies of the prior art.

### SUMMARY

Certain exemplary embodiments disclosed herein include a passive electronic circuit for splitting a Peripheral Component Interconnect Express (PCIe) reference clock. The circuit comprises two splitting paths coupled between a clock driver and a plurality of loads, wherein each of the two splitting paths is connected, at one end through a first transmission line, to one output of a differential PCIe reference clock provided by the clock driver; wherein each of the two splitting paths includes a plurality of splitter branches, wherein each splitting branch comprises a first resistor connected in series to a second transmission line being connected in a series to a second resistor, wherein the second resistor is coupled to an input of one of the plurality of loads and the first resistor is coupled to the first transmission line through a splitting point.

Certain exemplary embodiments disclosed herein also include an apparatus integrated a computing device. The apparatus comprises a slot for providing connectivity to a motherboard of the computing device; a passive clock splitter for splitting a peripheral component interconnect Express (PCIe) reference clock; a plurality of integrated circuits (ICs), each of the plurality of ICs is configured to perform a different function, wherein the passive clock splitter is configured to drive the differential reference PCIe clock to the plurality of ICs.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a passive splitter implemented according to one embodiment.

FIG. 2 is a diagram showing the clock signal as received at one of the loads.

FIG. 3 is a flowchart illustrating the method for designing a passive splitter implemented according to one embodiment.

FIG. 4 is block diagram of a PCIe card implementing the disclosed passive clock splitter.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

According certain exemplary embodiments, a passive splitter for splitting a differential reference clock into a plurality of reference clocks without attenuating the amplitude of the input clock signal is disclosed. The reference clock is a PCI Express (PCIe) reference clock. In one embodiment, the reference clock is a 100 MHz square wave differential clock that has to drive a load at each end. Each load has a capacitance value 2 pF. As noted above, connecting two or more loads in parallel, leads to significant reflections.

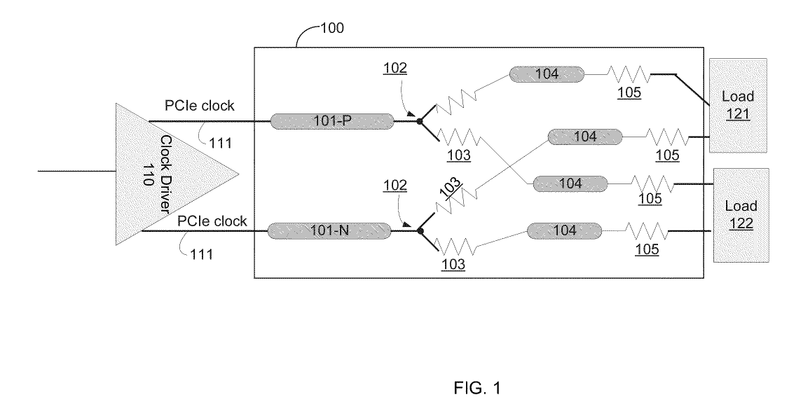

FIG. 1 shows a schematic diagram of the clock passive splitter 100 implemented according to one embodiment. The splitter 100 is connected to a single clock driver 110 that drives a PCIe reference clock 111. The PCIe reference clock 111 is a wideband signal that consists of a fundamental frequency of 100 MHz with odd harmonics, i.e., such 300 MHz, 500 MHz, 700 MHz, and so on. To allow clock splitting in view of the above clock's properties the splitter 100 is connected to two loads 121 and 122, each having a capacitance value of 2 pF. In an embodiment, the load can be an I/O of a chip with a capacitance value 2 pF. The load can also be a 2 pF capacitor.

In order to allow efficient clock splitting, each of the loads 121 and 122 has to present the capacitance of the load (2 pF or lower) in a low frequency (100 MHz) and decreases the impedance to 50Ω as the frequency increases. As a result, each of the splitting points 102 have to sense 50Ω as a load in high frequencies (300 MHz and higher harmonics) and a capacitive load in low frequency (100 MHz).

The clock signal is a differential signal that outputs on a differential pair consisting of driver stage transmission lines 101-N and 101-P, each of which is connected to the driver 110. Each of the driver stage transmission lines 101-N and 101-P is designed to have 50Ω characteristic impedance. The transmission line 101-N may carry the negative component, while the transmission line 101-P carries the positive component of the differential clock signal (111). Each load 121 and 122 receives the two components of the differential clock signals. With this aim, a splitting point 102 is connected at one end of each of the transmission lines 101-N and 101-P.

According to certain embodiments, the design of each transmission line 101 or 104 to have a 50Ω characteristic is realized through a strip line or a micro strip. The micro strip is typically fabricated on an upper layer of the substrate, while a strip line is fabricated between two layers of the substrate.

The route between a driver's 110 output and a load (121 or 122) is referred to hereinafter as a “splitting path”, and the route between a load (121 or 122) and a splitting point 102 is referred to hereinafter as a “splitting branch”. As shown in FIG. 1, there are 4 splitting branches in the splitter 100, each of which comprises a series connection of a resistor 103 a transmission line 104, and a resistor 105 connected to a load 121 or 122. The resistance value of each of the resistors 103 and 105 in each branch is determined as a function of the reference impedance the PCIe clock wire. In the splitter 100, the resistance value of each resistor 105 and 103 is 50Ω which is the reference impedance of a PCIe bus.

In one embodiment, each of the load stage transmission lines 104 is also designed to have 50Ω characteristic impedance. A stage transmission line 104 is coupled to a respective load (121, and 122) through a resistor 105 which is connected in series between the transmission line 104 and the respective load.

At each splitting point 102, a resistance network having 2×100Ω resistors in parallel is created by connecting two 50Ω resistors together to the splitting point. It should be noted that the resistors 102 must be located right on the spitting point, in order to minimize reflections, as the impedance is kept close to 50Ω in every point without extra line segments. In a preferred embodiment, the resistors 103 are located right on the splitting point 102, i.e., without any connection to extra line segments. This is performed in order to minimize reflections and to keep the impedance matching as 50Ω.

It should be appreciated that due to the series connection of the resistors 103 and 105 in each splitting branch, the resistors affect the matching only in high frequencies (300 MHz and higher harmonics) of the PCIe reference clock 111 and avoid reflections without reducing amplitude of the clock 111.

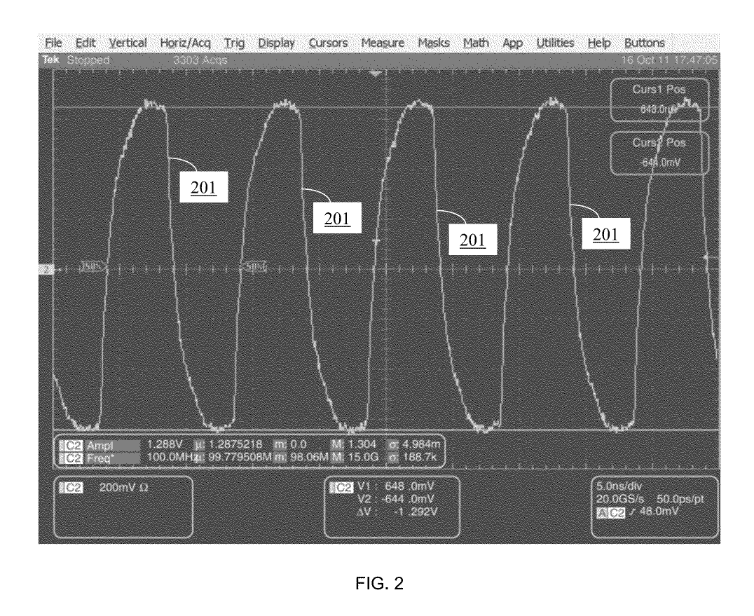

FIG. 2 shows a plot of a PCIe reference clock signal 201 as received at the loads after being split by the splitter 100. The clock signal 201 is a PCIe 100 MHz reference clock signal. As illustrated in FIG. 2, the clock's frequency is 100 MHz and it has a square-like shape. Therefore, the splitter 100 does not distort the clock signal, and in practical, without reflections on the clock's edges.

The splitter 100 provides a specific embodiment of a 1:2 splitter. It should be noted that the embodiments discussed herein can be used in order to design an 1:N splitter, n-clock, where n is an integer number greater than 2 that splits a reference clock signal for ‘n numbers of loads. In the general case of n loads, each resistor in the splitting branch is set to a resistance value and each transmission line's characteristic impedance is determined by the following equation:

$$\frac{n * Z}{2}$$

where, n is the number of loads and Z is the reference impedance (50Ω in a PCIe case).

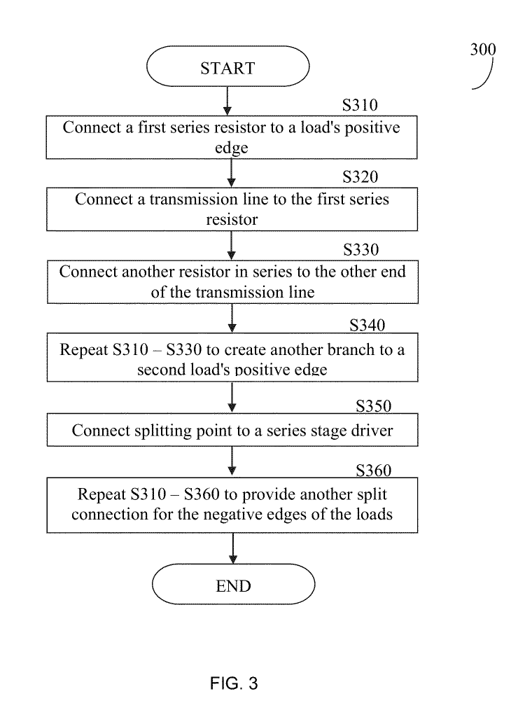

FIG. 3 shows an exemplary and non-limiting flowchart 300 for designing a 1:2 reference clock of a PCIe bus according to an embodiment. The method is described with a reference to a specific embodiment of a 1:2 splitter design merely for the ease of the description and the sake of simplicity. The method can be adapted to a design of higher splitting levels as disclosed hereinabove. The method will be discussed with reference to the splitter shown in FIG. 1.

At S310, each load (e.g., load 121, 122) is preceded with a series resistor (e.g. resistor 105) connected to the load's input pins. The resistor 105 is connected in series with the capacitive load, thus enabling frequency-varied impedance. In the fundamental frequency of the clock signal (e.g., 100 MHz), the capacitor (not shown) of the load dominates, while in high frequencies the capacitor's impedance of the load is linearly reduced and the resistor 105 becomes more dominant. The resistance value of the series resistor is a function of the impedance of PCIe clock wire. In exemplary embodiment, the resistance value is 50Ω.

At S320, the loads (121, 122) through the first resistor (105) are connected in series to 50Ω characteristic impedance realized by the load stage transmission line 104. The transmission line 104 has the necessary length according to design requirements of the circuit, IC, or chip that the splitter is designed to support. The requirements may be defined in part, based on the board size, locations of the circuits that should receive the clock, and so on.

At S330, another resistor (e.g., resistor 103) is connected in series to the other end of the transmission line and to a first of two pins of a splitting at the splitting point (e.g., splitting point 102). This would result in a splitting branch comprising a first resistor (105) connected at one end to a load and at the other end to a transmission line (104). The transmission line (104) is connected at its other end to a second resistor (103), which is connected in series to a first pin of the splitting point (102).

At S340, S310 through S330 are repeated to create another splitting branch which is also connected to a second pin of the splitting point. This creates at the splitting point (e.g., splitting point 102), a resistance network having 2×100Ω resistors in parallel. In an embodiment, the resistor (103) must be located right on the spitting point, in order to minimize reflections, as the impedance is kept close to 50Ω in every point without extra line segments.

At S350, the splitting point 102 is connected in series to a driver stage transmission line (101) which is further connected to one of the outputs of the clock driver (110). In an embodiment, the driver stage transmission line has 50Ω characteristic impedance.

At S360, S310 through S350 are repeated to provide a split connection between a load and the other output of the clock driver (110).

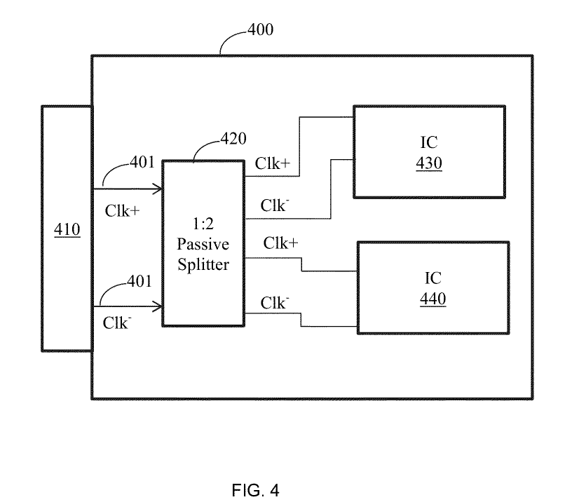

FIG. 4 shows an exemplary and non-limiting block diagram of a PCIe card 400 implementing the disclosed passive clock splitter. The PCIe 400 is connected to a PCIe slot 410. Through the PCIe slot, a PCIe reference clock 401 and other signals required for the operation of the PCIe bus are input and output.

According to the disclosed embodiments, a passive splitter 420 splits the differential signal of the reference clock 401 to two integrated circuits (IC) 430 and 440. The structure and the functionally of the splitter 420 are discussed in greater detail below.

Each of the ICs 430 and 440 may perform different functionalities and tasks. In an embodiment, the ICs 420 and 430 are different modules of an electronic computing device, such as a laptop computer, a smartphone, a tablet computer, a personal digital assistant, a wearable computing device, a remote alarm terminal, a kiosk, and the like. In an embodiment, the IC 420 is a Wi-Fi network interface while the IC 430 is a Wi-Gig network interface. The Wi-Gig as defined in the IEEE 802.11ad standard, published Dec. 28, 2012, specifies the communication protocol for the 60 GHz frequency band. The Wi-Fi as specified, for example, in the IEEE standard 802.11n/g allows devices to exchange data wirelessly over a computer network, including high-speed Internet connections.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. All statements herein reciting principles, aspects, and embodiments of the invention, as well as specific examples thereof, are intended to encompass both structural and functional equivalents thereof. It is intended that such equivalents include both currently known equivalents as well as equivalents developed in the future, i.e., any elements developed that perform the same function, regardless of structure. Other hardware, conventional and/or custom, may also be included.

Similarly, Also as used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a computer, laptop computer, a tablet or mobile phone or server, to perform various functions and (c) to circuits, such as a microprocessor(s) or a portion of a microprocessor(s), that require software or firmware for operation, even if the software or firmware is not physically presence. This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware.

What is claimed is:

1. A passive electronic circuit for splitting a Peripheral Component Interconnect Express (PCIe) reference clock, comprising:
two splitting paths coupled between a clock driver and a plurality of loads, wherein each of the two splitting paths is connected, at one end through a first transmission line, to one output of a differential PCIe reference clock provided by the clock driver;
wherein each of the two splitting paths includes a plurality of splitter branches, wherein each splitting branch comprises a first resistor connected in series to a second transmission line being connected in a series to a second resistor, wherein the second resistor is coupled to an input of one of the plurality of loads and the first resistor is coupled to the first transmission line through a splitting point.

2. The circuit of claim 1, wherein the resistance value of each of the first resistor and the second resistor is a function of a number of the splitting branches and a reference impedance of the PCIe clock wire.

3. The circuit of claim 2, wherein the characteristic impedance of each of the first transmission line and the second transmission line is a function of a number of the splitting branches and a reference impedance of the PCIe clock wire.

4. The circuit of claim 3, wherein the reference load impedance is 2 pF.

5. The circuit of claim 4, wherein the resistance value of each of the first resistor and the second resistor is 50Ω.

6. The circuit of claim 5, wherein the characteristic impedance of the first transmission line and the second transmission line is 50Ω.

7. The circuit of claim 1, wherein the circuit is connected in a PCIe card including at least a plurality of integrated circuits (ICs) respectively coupled to the plurality of loads, each of the plurality of ICs is configured to perform a different function, wherein the circuit drives the differential reference PCIe clock to the plurality of ICs.

8. The circuit of claim 7, wherein the plurality of ICs includes at least a first network Wi-Fi interface compliant with the IEEE 802.11n/g standard and a second network Wi-Gig interface compliant with the IEEE 802.11ad standard.

9. The circuit of claim 1, wherein the PCIe card is integrated in a computing device including any one of: a laptop computer, a smartphone, a tablet computer, a personal digital assistant, a wearable computing device, a remote alarm terminal, and a kiosk.

10. An apparatus integrated a computing device, comprising:
a slot for providing connectivity to a motherboard of the computing device;
a passive clock splitter for splitting a peripheral component interconnect Express (PCIe) reference clock;
a plurality of integrated circuits (ICs), each of the plurality of ICs is configured to perform a different function, wherein the passive clock splitter is configured to drive the differential reference PCIe clock to the plurality of ICs.

11. The apparatus of claim 1, wherein the passive clock splitter includes:
two splitting paths coupled between a clock driver and a plurality of loads of the plurality of ICs, wherein each of the two splitting paths is connected, at one end through a first transmission line, to one output of a differential PCIe reference clock provided by the clock driver;
wherein each of the two splitting paths includes a plurality of splitter branches, wherein each splitting branch comprises a first resistor connected in series to a second transmission line being connected in a series to a second resistor, wherein the second resistor is coupled to an input of one of the plurality of loads and the first resistor is coupled to the first transmission line through a splitting point.

12. The apparatus of claim 11, wherein the resistance value of each of the first resistor and the second resistor is a function of a number of the splitting branches and a reference impedance of the PCIe clock wire.

13. The apparatus of claim 11, wherein the characteristic impedance of each of the first transmission line and the second transmission line is a function of a number of the splitting branches and a reference impedance of the PCIe clock wire.

14. The apparatus of claim 13, wherein the reference load impedance is 2 pF.

15. The apparatus of claim 14, wherein the resistance value of each of the first resistor and the second resistor is 50Ω.

16. The apparatus of claim 14, wherein the characteristic impedance of the first transmission line and the second transmission line is 50Ω.

17. The apparatus of claim 10, wherein the plurality of ICs includes at least a first network interface and a second network interface.

18. The apparatus of claim 17, wherein the first network interface is a Wi-Fi interface compliant with the IEEE 802.11n/g standard and the second network interface is a Wi-Gig interface compliant with the IEEE 802.11ad standard.

19. The apparatus of claim 10, wherein the PCIe card is integrated in a computing device including any one of: a laptop computer, a smartphone, a tablet computer, a personal digital assistant, a wearable computing device, a remote alarm terminal, and a kiosk.
